(19) United States
(12) Patent Application Publication
(10) Pub. No.: US 2009/0238960 A1
(43) Pub. Date: Sep. 24, 2009

(54) AMBIENT CURE PAINTING METHOD

(75) Inventors: David A. McCord, Medina, OH (US); Gregory A. Brainard, Spencer, OH (US); Thomas J. Staunton, Euclid, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/407,066

(22) Filed: Mar. 19, 2009

Related U.S. Application Data
(60) Provisional application No. 61/038,799, filed on Mar. 24, 2008.

(51) Int. Cl. B05D 3/02

(52) U.S. Cl. 427/140; 427/379

(57) ABSTRACT

Methods and compositions for coating a substrate with at least a basecoat layer and clearcoat layer allow quick repairs to damaged vehicle panels under ambient temperatures and without requirement of actinic or thermal radiation to cure the layers. At least one basecoat and one clearcoat layer may be applied to a substrate and the clearcoat layer may be buffed with less than 30 minutes allocated to curing the basecoat and clearcoat layers, under ambient conditions, prior to buffing. Methods and compositions are also taught for coating a substrate with at least a primer layer, a basecoat layer, and a clearcoat layer, in which the clearcoat layer may be buffed with less than about 45 minutes allocated to curing the primer, basecoat and clearcoat layers, under ambient conditions, prior to buffing.

This application claims priority to U.S. Provisional Patent Application 61/038,799 filed on Mar. 24, 2008, the entirety of which is incorporated herein by reference.

### BACKGROUND OF THE INVENTION

The present invention relates to methods and compositions for repairing damage to painted surfaces, particularly vehicle surfaces like trunk panels, door panels, hoods, roof panels, side panels, and the like, though, some embodiments of the invention may be useful processes for painting a substrate. More specifically, the present invention describes an ambient temperature, refinish painting process or spot repair process comprising the application of at least one layer of a solvent-borne basecoat composition and at least one layer of a solvent-borne clearcoat composition. The methods described provide a total overall cure time for all applied layers of less than about 30 minutes in a process that does not include applying a primer coat layer, but includes applying at least one layer of a basecoat and at least one layer of a clearcoat; and less than about 45 minutes in a process that involves applying at least one layer of each of a primer coat, basecoat, and clearcoat. These total cure times are at ambient temperatures without the need to bake or otherwise heat the repaired area, thus, ovens, heat guns and lamps are not required according to the methods described herein.

Motor vehicle panels, such as bumpers, doors, quarter panels, hoods, and the like are usually metal or plastic substrates coated by a coating system that comprises at least a basecoat, which is often tinted, and a clearcoat, to protect the basecoat from environmental hazards. In some cases, a primer coat is applied to the substrate before the basecoat to provide enhanced protection of the substrate against environmental conditions and/or to improve adhesion of the basecoat to the substrate.

From time to time, the coating on a vehicle panel can become scratched or otherwise damaged, thereby necessitating a repair either for purely aesthetic reasons, or to preserve the integrity of the panel from further damage, such as from rust.

A variety of methods and products have been developed for “spot” repairing damaged coatings, such as the damage caused by surface impacts. However, existing methods for making these types of repairs, particularly spot repairs of damage that extends through the clearcoat and into the basecoat and/or primer coat, are very time consuming to perform effectively, generally owing to the extensive cure times between layers. The large amount of time required to effectively repair scratches in vehicle panels using existing repair methods and products is a significant detriment to undertaking the repair. The more time required to perform the repair, the less number of repairs can be performed, and the greater amount of time that a vehicle owner will be without access to their vehicle. These raise the cost of each repair, making it less likely or desirable that a vehicle owner would make elective paint repairs, such as to relatively minor scratch and dent spot repairs. However, failure to timely make even spot repairs can leave the vehicle susceptible to further damage.

One approach to decrease repair time is to use a heat source to speed the drying or cure of the various applied coating layers or to apply actinic radiation. The latter approach is described in U.S. Patent Publication No. 2007/0116866. However, using heat to decrease cure time requires having access to a heat source, such as an oven or a heat gun or specialized lamps, such as IR lamps. In many environments, such resources are not available to the repair technician. Moreover, these types of conventional heat source can be expensive to acquire and operate. Actinic radiation sources, such as UV lamps, have similar limitations.

It remains desirable, therefore, to develop a system for spot repairing a painted substrate, or otherwise spot painting a substrate, wherein the repair constitutes at least application of one or more layers of a basecoat compositions and at least one or more layers of clearcoat composition, which can be cured (dry to sand and buff) at ambient temperatures, without the requirement of applying thermal or actinic radiation to the substrate or the applied layers to enhance drying or cure, in less than 1 hour of total curing time (i.e., time dedicated to allowing the layers to cure through to the point at which the final clearcoat layer can be buffed). It would further be useful if the repaired coating area substantially equaled the color and physical performance of the surrounding, undamaged coating areas, so that the appearance of the repaired area is substantially indistinguishable from the surrounding undamaged coating.

### DETAILED DESCRIPTION OF THE INVENTION

The present invention describes a method for and basecoat and clearcoat compositions, which are useful for imparting onto a substrate a cured coating comprising at least one layer of basecoat and one layer of clearcoat, that requires a maximum total curing time of less than about 30 minutes under ambient temperatures and without using a heat or other radiation source to speed drying or curing.

In another embodiment, the present invention describes a method for and primer, basecoat, and clearcoat compositions, which are useful for imparting onto a substrate a cured coating comprising at least one layer of primer, at least one layer of basecoat and at least one layer of clearcoat, that requires a maximum total curing time of less than about 45 minutes under ambient temperatures and without using a heat or other radiation source to speed curing.

In one embodiment, the methods and systems described herein provide for rapid repair of vehicles that have suffered paint damage, without requiring a heat or other radiation source.

For purposes of clarity, it will be understood that the methods described herein relate to the application of at least a basecoat layer and a clearcoat layer to a substrate. In some embodiments, the additional application of a primer coat layer is also disclosed. The contexts in which such methods may be usefully practiced may include, but are not limited to, the aftermarket repair of a portion of a previously painted substrate that has been damaged, so as, for example, to correct the appearance of the damaged portion; however, as will be understood, the methods may be used on a new substrate that has not been previously painted.

The method comprises the step of providing a suitable panel (synonymous with substrate) having a damaged or unfinished portion to painted. For purposes herein, the portion of the panel to receive the coating compositions according to the methods described herein will be referred to as the “repair area”. The panel may be any material or combination of materials that is conventionally finished with a basecoat/clearcoat finishing system. In a one embodiment, the panel is a vehicle panel, such as a door panel, hood, trunk panel, quarter panel, and the like.

The method may comprise one or more optional steps directed to preparing the repair area for subsequent application of the coating compositions according to the methods described herein. These steps may include washing the repair area with one or more solvents and/or cleaning agents; sanding the repair area to remove surface imperfections; and repairing or replacing missing portions of the substrate or surface imperfections (dents, for example). This latter step may involve using suitable, conventional body fillers to fill holes, dents, or other imperfections in the substrate. If priming is required, the method comprises the step of applying to the repair area an ambient temperature curing, solvent-borne primer coat composition. For purposes of clarity, “ambient temperatures” refers to temperatures of between about 55° F. and about 115° F. More usefully, the primer coat composition will cure at ambient temperatures (dry to sand) in less than about 20 minutes, and more usefully, less than about 15 minutes.

A particularly useful primer coat composition may comprise a solvent-borne blend of components comprising:
(i) at least one polyol resin;
(ii) at least one blocked amine;
(iii) at least one polyisocyanate;
(iv) a metal catalyst, such as a tin compound, for accelerating the isocyanate/hydroxyl reaction; and
(v) a volatile organic acid.

Polyol resins useful in the primer coat composition may include monomeric compounds and polymeric compositions having two or more hydroxyl groups per molecule, notwithstanding the optional presence of other functional groups such as carboxyl, amino, urea, carbamate, amide and epoxy groups. The primer composition may comprise a single polyol resin or a blend of polyol resins, which may include blends of polymeric polyols, monomeric polyols or both.

Suitable monomeric polyols may include diols such as ethylene glycol, dipropylene glycol, 2,2,4-trimethyl 1,3-pentanediol, neopentyl glycol, 1,2-propanediol, 1,4-butanediol, 1,3-butanediol, 2,3-butanediol, 1,5-pentanediol, 1,6-hexanediol, 2,2-dimethyl-1,3-propanediol, 1,4-cyclohexanedimethanol, 1,2-cyclohexanedimethanol, 1,3-cyclohexanedimethanol, 1,4-bis(2-hydroxyethoxy)cyclohexane, trimethylene glycol, tetramethylene glycol, pentamethylene glycol, hexamethylene glycol, decamethylene glycol, diethylene glycol, triethylene glycol, tetraethylene glycol, norbornylene glycol, 1,4-benzenedimethanol, 1,4-benzenediethanol, 2,4-dimethyl-2-ethylenehexane-1,3-diol, 2-butene-1,4-diol, and higher level polyols such as trimethylolethane, trimethylolpropane, trimethylolhexane, triethylolpropane, 1,2,4-butanetriol, glycerol, pentaerythritol, dipentaerythritol, and the like.

Exemplary polymeric polyols may include polyether polyols, polyester polyols, acrylic polyols, polycaprolactone polyols, polyurethane polyols, and polycarbonate polyols. Acrylic polyols are particularly desirable.

Polyether polyols may be prepared as the reaction products of ethylene or propylene oxide or tetrahydrofuran with diols or polyols. Polyethers derived from natural products such as cellulose and synthetic epoxy resins may also be used in this invention. Polyester polyols may be prepared by the reaction of diols, triols or other polyols with di- or polybasic acids. Alkyds with hydroxy functional groups may be prepared in a similar process except that mono functional fatty acids may be included. Acrylic polyols may be prepared as the polymerization products of an ester of acrylic or methacrylic acid with hydroxy containing monomers such as hydroxyethyl, hydroxypropyl or hydroxybutyl ester of acrylic or methacrylic acid. Acrylic polymers can also contain other vinyl monomers such as styrene, acrylonitrile vinyl chloride and others. Polyurethane polyols may be prepared as the reaction products of polyether or polyester polyols with diisocyanates.

Numerous blocked amines well known in the art may be used in the present invention. Blocked amines are herein defined as those amines that will produce primary and secondary amines when exposed to water or water vapor, with or without the release of the respective aldehyde or ketone. Deblocking of the blocked amine may be accelerated by the organic acid (discussed below). Preferred blocked amines include aldimines, ketimines and oxazolidines. Aldimines are commercially produced by the condensation of aldehydes with primary diamines, followed by removal of the water by-product. Ketimines are produced in a similar fashion, with ketones being utilized in place of the aldehydes. Oxazolidines are produced by condensing either ketones or aldehydes with alkanolamines, with the water by-product again being removed.

The primer composition may include any isocyanate functional molecule conventionally used making polyurethanes or polyureas. Typical isocyanate functional molecules useful in the compositions of this invention will have an average of at least two isocyanates per molecule, and more usefully three isocyanates per molecule. Representative polyisocyanates useful in the present invention include the aliphatic compounds such as ethylene, trimethylene, tetramethylene, pentamethylene, hexamethylene, 1,2-propylene, 1,2-butylene, 2,3-butylene, 1,3-butylene, ethylidene and butylidene diisocyanates; the cycloalkylene compounds such as 3-isocyanatomethyl-3,5,5-trimethylcyclohexylisocyanate, and the 1,3-cyclopentane, 1,3-cyclohexane, and 1,2-cyclohexane diisocyanates; the aromatic compounds such as m-phenylene, p-phenylene, 4,4-diphenyl, 1,5-naphthalene and 1,4-naphthalene diisocyanates; the aliphatic-aromatic compounds such as 4,4-diphenylene methane, 2,4- or 2,6-toluene or mixtures thereof, 4,4′-toluidine, and 1,4-xylylene diisocyanates; the nuclear substituted aromatic compounds such as dianisdine diisocyanate, 4,4′-diphenylether diisocyanate and chlorodiphenylene diisocyanate; the triisocyanates such as triphenyl methane-4,4′,4″-triisocyanate, 1,3,5-triisocyanatebenzene and 2,4,6-triisocyanate toluene; and the tetraisocyanates such as 4,4′-diphenyl-dimethyl methane-2,2′,5,5′-tetraisocyanate; the polymerized polyisocyanates such as dimers and trimers, and other various polyisocyanates containing biuret, urethane, and/or allophanate linkages.

Preferred polyisocyanates include dimers and trimers of hexamethylene diisocyanate, isophorone diisocyanate, and mixtures thereof.

The primer composition further includes a suitable catalyst used for the reaction of active hydrogen containing compounds and isocyanates. Suitable catalysts for this reaction include, for example, tertiary amines, and metal catalysts. Typical metal catalysts may include tin, zinc, copper and bismuth materials such as dibutyl tin dilaurate, stannous octanoate, dibutyl tin diacetate, dibutyl tin dilaurate, dibutyl tin oxide, tetrabutyl-1,3-diacetoxydistannoxane, zinc octoate, copper naphthenate, bismuth octoate and the like.

The primer composition may further include a volatile organic acid, which may be a carboxylic acid. Particularly useful organic acids include volatile carboxylic acids, including, for example, formic acid, acetic acid, propionic aid, butyric acid, isobutyric acid, valeric acid, isovaleric acid, hexanoic acid, heptanoic acid, and octanoic acid, etc, and blends thereof. Acetic and propionic acid are particularly useful, with acetic acid being desirable for its volatility. As indicated above, these acids are particularly useful for accelerating deblocking of the amine.

The primer composition may include one or more inert organic solvents, such as aliphatic and aromatic hydrocarbon solvents, exemplified by toluene, xylene, ethyl benzene, aromatic naphtha, mineral spirits, hexane, aliphatic naphtha, and the like, and oxygenated solvents, such as ketone solvents, ester solvents, ether solvents, alcohols and the like, including butyl acetate, ethylene glycol monoethyl ether acetate, ethylene glycol monobutyl ether acetate, methyl amyl ketone and methyl isobutyl ketone, methanol, ethanol, propoanol, and the like.

One particularly useful primer coat composition may be obtained by blending P30 series SpectraPrime™ primer, available from The Sherwin-Williams Company, with SR15—SpectraPrime Speed Reducer, available from The Sherwin-Williams Company, with UH80 ULTRA System Low VOC Air Dry Hardener, available from The Sherwin-Williams Company. In another embodiment of the primer coat composition, the reducer may comprise about 0.5% by weight of a metal catalyst, about 24.1% by weight of at least one aliphatic polyamine, and about 75.4% by weight of at least one inert solvent. The primer, reducer and hardener may be blended in a ratio of about 2:2:1.

The primer coat composition may be applied by any conventional means; however, spray application is a particularly useful application means. One or more primer coats may be applied. Where multiple primer coats are applied, it may be useful according to the methods of the present invention to provide a flash time for each intermediate layer, at ambient temperatures, of less than about 5 minutes, in other embodiments, less than 2 minutes, in still further embodiments, less than about 1 minute, in still further embodiments, less than about 45 seconds, and in still further embodiments, about 30 seconds. Flash times of between about 30 seconds and 5 minutes are useful, or alternatively, between about 30 seconds and about 2 minutes. In some embodiments, there may be substantially no flash time associated with the primer coats. The flash time may be no longer than that minimal time between the first application pass and the second application pass in a conventional wet on wet application process.

The primer coat compositions described herein will preferably cure to allow sanding of the primer coat layer within about 20 minutes at ambient temperatures and, preferably about 15 minutes at ambient temperatures. Application of thermal radiation, such as infrared radiation, to the primer coat layer may be employed as a curing process, but is not required. However, where thermal radiation is applied as a curing process, the cure time of the primer coat layer may be reduced to about 5 minutes.

Following the optional application of a primer coat layer, one or more layers of a solvent-borne basecoat composition may be applied to the damaged area. Most usefully, the basecoat layer may be a refinish basecoat layer based on urethanes, acrylics, polyesters, polyethers, and the like. The basecoat layer may be tinted with suitable colorants and pigments so that the basecoat layer will match the basecoat color of the surrounding undamaged area. However, in other embodiments, it will be recognized that it may be useful to provide a different basecoat color than the surrounding, undamaged area.

Particularly useful basecoat compositions for use in connection with the methods of the present invention may include Ultra 7000 basecoat compositions commercially available from The Sherwin-Williams Company, which may be blended with a suitable commercially available reducer, such as RHF Reducers available commercially from The Sherwin-Williams Company.

As with the primer coat composition, layers of basecoat composition may be applied by any conventional means; however, spray application is a particularly useful means.

According to the methods of the present invention, at least a first basecoat layer may be applied to the repair area. The method further comprises force flashing the basecoat layer with a venturi dryer or other source or ambient air flow directed to the basecoat layer for a flash time. A useful flash time may be less than about 5 minutes, though in other embodiments, less than about 2 minutes, and in still further embodiments, about 90 seconds. Flash times of between about 1 minute and about 5 minutes are particularly useful. The venturi dryer may be an air dryer gun. The air flow supplied by the air source may be between about 5 to about 20 cfm.

Following the flash time, subsequent basecoat layers may be applied until hiding is achieved. Usefully, each applied layer will be flashed using the venturi dryer for a flash time, which may be up to about 5 minutes, preferably from about 1 minute to about 2 minutes. Longer flash times with the venturi dryer may be undertaken, but under the embodiments contemplated herein, a flash time of between about 1 minute and about 2 minutes is desirable.

In some embodiments, it may be useful to apply as the final basecoat layer a droplet coat to help with orientation of metallic pigments, if present in the basecoat composition. This final basecoat layer may be force flashed with the venturi dryer as provided above.

Following application of the final basecoat layer and flash time with the venturi dryer, one or more layers of a clearcoat composition may be applied to the basecoat layer. Clearcoat compositions useful for the present invention may include those described in U.S. patent application Ser. No. 11/753,171, which is incorporated herein by reference and U.S. Pat. No 7,279,525, which is also incorporated herein by reference.

A particularly useful clearcoat composition according to the references cited above may be formed according to the following formula:

| Component | Weight Percent |
|---|---|
| Acrylic Resin | 38.9 |
| Low molecular weight polyester polyol | 1.0 |
| reactive diluent | |
| N-Butyl Acetate | 15.5 |
| 2-butoxyethyl acetate | 1.6 |
| Ethyl 3-ethoxypropionate | 3.7 |
| Methyl N-Amyl Ketone | 6.0 |
| Methyl N-Propyl Ketone | 2.0 |
| Acetone | 16.0 |
| Light stabilizer | 1.1 |
| Modified silicone solution¹ | 0.2 |
| Acetic acid | 0.7 |
| Dibutyltin dilaurate | 0.1 |
| HDI Trimer² | 13.1 |

¹Byk 310 available from Byk-Chemie.
²Tolonate HDT, available from Rhodia.

As previously described, the clearcoat composition can be applied by any application method known in the art, but preferably will be spray applied. The basecoat and the clearcoat may each be applied to give a dry film thickness of about 0.2 to about 6, and especially about 0.5 to about 3.0 mils.

In a particularly useful embodiment, two layers of clearcoat composition may be applied to the repaired surface wet on wet to a dry film thickness of between about 1.5 and 2.0 mils.

Following application of the clearcoat layers, sanding and buffing of the repaired area may be completed as necessary to improve appearance. As indicated above, the clearcoat layer may be dry to sand and buff in about 15 minutes at ambient temperatures. Additionally, the clearcoat may be sufficiently dry to prevent ambient dust from sticking to the coating, in less than about 10 minutes. As with the primer coat layer, thermal radiation curing process may be employed in conjunction with the clearcoat layer to significantly reduce the cure time to sand and buff. Using heat may, in some embodiments, facilitate curing the clearcoat to allow sanding and buffing in about 5 minutes or less.

The selection of materials described herein to form a basecoat/clearcoat system, and, in another embodiment, a primer coat/basecoat/clearcoat system, in connection with use of the venturi dryer to flash the basecoat layers, facilitate a process for spot repairing a vehicle that can be completed (dry to buff) under ambient conditions with less than about 30 minutes, and preferably less than about 20 minutes, of total cure time for the basecoat/clearcoat system and less than about 45 minutes, and preferably less than about 35 minutes, of total cure time (dry to buff) for the primer coat/basecoat/clearcoat system. By using heat (thermal radiation) in the cure process of the primer coat and clearcoat, in place of or in addition to a force drying process using ambient air, the total cure time may be reduced to about 10 to 15 minutes in the basecoat/clearcoat system and about 15 to 20 minutes in the primer coat/basecoat/clearcoat system of the present invention. Importantly, however, the system can be applied by methods described herein that do not require use of a thermal or actinic radiation source such as a heat lamp or UV lamp. However, where it may be desirable to apply heat to facilitate cure, heat may be supplied by a heat lamp, oven, or hot air dryer. Other conventional heat sources used in the refinishing arts may also be used.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A method of coating a substrate, the method comprising the steps of:
applying at least a first layer of an ambient cure basecoat composition to a substrate; force flashing the basecoat composition with ambient temperature air;
applying at least a first layer of an ambient cure clearcoat composition to the layer of basecoat composition;
curing the clearcoat composition;
wherein the method is substantially free of the use of applied thermal or actinic radiation to facilitate cure of the basecoat or clearcoat compositions.

2. The method of claim 1, wherein the at least a first basecoat layer is force flashed with a flow of ambient temperature air for less than about 5 minutes.

3. The method of claim 1, wherein the at least a first basecoat layer is force flashed with a flow of ambient temperature air for less than about 2 minutes.

4. The method of claim 3, wherein the first basecoat layer is force flashed with a venturi dryer.

5. The method of claim 1, further comprising the steps of:
applying a second layer of an ambient cure basecoat composition on top of the first layer of the basecoat composition; and
force flashing the second basecoat layer with a flow of ambient temperature air.

6. The method of claim 5, wherein the first layer of basecoat composition is force flashed with ambient temperature air for between about 1 to about 5 minutes; and wherein the second layer of basecoat composition is force flashed with ambient temperature air for between about 1 to about 5 minutes.

7. The method of claim 6, wherein the basecoat composition is tinted to substantially match an existing color of the substrate.

8. The method of claim 7, wherein the substrate is a vehicle panel.

9. The method of claim 6, wherein, the basecoat layers are force flashed with a venturi dryer.

10. The method of claim 1, wherein, at ambient temperatures, the clearcoat composition will substantially cure to allow buffing of the clearcoat within 15 minutes after application.

11. A method of making repairs to a substrate, the method comprising the steps of:
applying at least a first layer of an ambient cure primer composition to a substrate, wherein the primer composition sufficiently cures at ambient temperatures to allow sanding of the primer layer within 20 minutes after application; applying at least a first layer of an ambient cure basecoat composition to the primer layer;
force flashing the basecoat composition with a flow of ambient temperature air for between about 1 to about 5 minutes;
applying at least a first layer of an ambient cure clearcoat composition to the layer of basecoat composition; and
curing the clearcoat composition;
wherein the steps of curing the primer, basecoat and clearcoat compositions do not require use of applied thermal or actinic radiation.

12. The method of claim 11, wherein the primer composition is a solvent-borne blend comprising:
(a) at least one polyol resin;
(b) at least one blocked amine;
(c) at least one polyisocyanate;
(d) a metal catalyst that accelerates an isocyanate/hydroxyl reaction; and
(e) a volatile organic acid.

13. The method of claim 11, further comprising the step of force flashing the primer composition with a flow of ambient temperature air for between about 30 seconds and 2 minutes.

14. The method of claim 13, comprising using a venturi dryer to provide the flow of ambient temperature air.

15. The method of claim 11, wherein, at ambient temperatures, the clearcoat layer is cured to allow buffing within 20 minutes after application.

16. A method of spot repairing damage to the color coat of a vehicle panel, comprising the steps of:
applying to the area of damage at least one layer of a pigmented basecoat composition having a color that substantially matches the color coat of the vehicle panel surrounding the area of damage;
force flashing the layer of pigmented basecoat composition with ambient temperature air for between about 1 to about 5 minutes;
optionally, applying at least a second layer of the pigmented basecoat composition on top of the first layer of pigmented basecoat composition;
applying to the basecoat layer at least one layer of a clearcoat composition wherein the clearcoat composition is curable at ambient temperatures to allow buffing in less than about 20 minutes after application; and
buffing the clearcoat layer.

17. The method of claim 16, wherein, prior to buffing the clearcoat layer, the total time allocated to curing the first basecoat layer and the clearcoat layer is less than about 30 minutes at ambient temperatures.

18. The method of claim 16, further comprising the steps of:
applying at least a first layer of an ambient cure primer composition to the area of damage prior to the step of applying the at least one layer of a pigemented basecoat composition.

19. The method of claim 18, wherein, prior to buffing the clearcoat layer, the total time allocated to curing the first primer layer, the first basecoat layer and the clearcoat layer is less than about 45 minutes at ambient temperatures.

20. The method of claim 18, wherein actinic radiation is not used in curing any of the primer, basecoat or clearcoat compositions.

21. The method of claim 18, wherein thermal radiation above ambient temperatures is not used in curing any of the primer, basecoat or clearcoat compositions.

22. A method of coating a substance, the method comprising the steps of:
applying at least a first layer of a solvent-borne basecoat composition to a substrate;
applying a curing process to the first basecoat layer for a period of less than about five minutes, the curing process selected from the group consisting of force flashing with ambient temperature air, thermal radiation, and blends thereof;
optionally, applying at least a second layer of the pigmented basecoat composition on top of the first layer of pigmented basecoat composition;
applying a curing process to the optional second basecoat layer for a period of less than about five minutes, the curing process selected from the group consisting of force flashing with ambient temperature air, thermal radiation, and blends thereof; and
applying at least a first layer of a solvent-borne clearcoat composition to the top layer of basecoat composition; wherein, at ambient temperatures, the clearcoat layer is sufficiently cured to allow buffing within 20 minutes after application.

23. The method of claim 22, further comprising the step of applying thermal radiation to the clearcoat layer for up to about 5 minutes.
